(19) United States
(12) Patent Application Publication
(10) Pub. No.: US 2015/0137939 A1
(43) Pub. Date: May 21, 2015

(54) LOCKING SYSTEM AND METHOD FOR OPERATING A LOCKING SYSTEM

(71) Applicant: Martin SCHWAB, Obererlbach (DE)

(72) Inventor: Martin SCHWAB, Obererlbach (DE)

(21) Appl. No.: 14/083,858

(22) Filed: Nov. 19, 2013

(30) Foreign Application Priority Data
Nov. 19, 2013 (DE) 10 2013 112 730.4

(51) Int. Cl. G07C 9/00

(52) U.S. Cl. CPC G07C 9/00111
USPC 340/5.61

(57) ABSTRACT

Locking system (1), having at least one locking device (4) comprising a control device (5) designed for communication with at least one central server (8) via a network (7), with a lock (3) for locking a room and/or an object and a sensor device (10, 10a, 10b, 10c) allocated to the room and/or object, characterized in that the sensor device (10, 10a, 10b, 10c) is connected via an in particular serial communication link (13) to the locking device (4), wherein the control device (5) and/or an evaluation device (12) of the sensor device (10, 10a, 10b, 10c) is designed to evaluate the sensor data received from a sensor (11) of the sensor device (10, 10a, 10b, 10c), and the control device (5) is designed to transfer at least a part of the result data obtained in the evaluation to the server (8).

The invention relates to a locking system, having at least one locking device comprising a control device designed for communication with at least one central server via a network, with a lock for locking a room and/or an object and a sensor device allocated to the room and/or object. In addition, the invention relates to a method for operating a locking system of this type.

Locking devices, comprising locks, have long been known in the prior art and are used whenever an increased security requirement exists for a room or an object, for example an object is not to be moved away from a location or unauthorized access to a room is to be prevented. Here, the term “room” is to be understood broadly; it may be a room of a building, but also a rack, a holder, a container and the like.

The security requirement described often goes beyond unauthorized access, in that sensors are used there which check whether specific required environmental conditions are satisfied, for example temperature intervals are maintained, vibrations are kept within limits and the like. Finally, it is also known, particularly in the case of rooms, to provide actuators which can actively influence the conditions within the room, for example cooling devices, heaters, and the like.

Dealing with secured objects and/or rooms of this type becomes problematic whenever a multiplicity of such rooms and/or objects is to be protected. It has been proposed in this context to connect sensor devices, locking devices and actuators to a network, for example an Intranet or the Internet, so that a server, i.e. a central computing device, can be used to control and monitor the operation of all these devices. For this purpose, sensor data of the sensors, actuation data and readiness data of the locking devices and control commands and status messages of the actuators are dispatched and exchanged via the network, resulting in an extremely high utilization of the network and incurring very high costs if the network is to be designed for the corresponding data volumes. The same applies to the server, which has to process correspondingly large data volumes.

A further problem of networks of this type is the configuration of the individual network components, which in most cases can only be carried out extremely laboriously, entailing several days of maintenance work for the installation, particularly when a multiplicity of sensor devices, locking devices and actuators are to be connected to the network. Furthermore, it should be noted that in most cases an already existing network is used, via which other data are also to be exchanged between various devices, particularly also devices protected by the locking devices.

A specific example of an environment of this type involves data centers, in which a multiplicity of assembly racks for individual computer units are used, which are all monitored with sensors and are protected by locking devices with corresponding locks. Actuators, particularly in respect of cooling, are also often used in the context of data centers of this type with a great multiplicity of assembly racks.

The object of the invention is therefore to indicate a locking system with which the requirements for the network, particularly its bandwidth, can be significantly reduced.

To achieve this object, it is provided according to the invention in a locking system of the aforementioned type that the sensor device is connected via a communication link to the locking device, wherein the control device and/or an evaluation device of the sensor device is designed to evaluate the sensor data received from a sensor of the sensor device, and the control device is designed to transfer at least a part of the result data obtained in the evaluation to the server.

This means that the at least one sensor device itself, monitoring in particular the room and/or the object, no longer needs to be connected to the network, but instead, in the design according to the invention, the locking device acts as a type of “intermediate host”, wherein moreover all sensor data of the sensor device no longer need to be transmitted via the network to the server, i.e. the central computing device, but rather an evaluation to produce result data, the quantity of which can be significantly reduced, is already carried out by the sensor device itself and/or the locking device. Furthermore, it should be noted that it is not necessary in the case of many applications to have the sensor data and/or the result data derived therefrom available directly on the server, so that the locking system according to the invention can allow a substantial reduction in the data traffic in this respect also, and this will be examined in more detail below. The locking device as an essentially provided element is consequently used as an administration instance of a sub-unit of the system as a whole, so that, particularly if the sensor device, the locking device and the server in each case take over a part of the evaluation of the sensor data, a type of “cascaded intelligence” is produced which ensures a substantial reduction in the requirements for the network and/or the computing units, for example the server, used therein. The locking device therefore preferably forms an intelligent node point which connects the at least one sensor device and, where appropriate, at least one actuator to the server in a suitable manner, while reducing the data to be exchanged.

The electronic locking device, which can also be referred to in its entirety as an “electronic lock”, can communicate with the server via a protocol usable in the network, for example in the case of an Ethernet network via TCP/IP4, TCP/IP6, SNMP or the like. In particular, it is also conceivable for the Internet itself to be used. In this connection, it should also be noted that the communication link to the at least one sensor device (and, where appropriate, actuators) can also preferably be implemented as a communication network, for example via a bus system (I²C, CAN, Ethernet or the like), so that not every sensor device needs to be connected via a dedicated cable to the locking device. However, it is also conceivable for a serial communication link to be used. The locking device which, as already mentioned, forms a type of node point for sensor devices, is capable of recognizing the type and functionality of the sensor devices and their sensors, for which purpose, for example, an initial data exchange can take place.

The sensor data and/or result data can be forwarded in a defined cycle to the locking device which, if necessary following evaluation, can forward the result data, if necessary, however, also sensor data themselves, to the server, which preferably occurs less frequently. For example, the sensor devices can forward sensor data and, if necessary, additionally status data and/or result data to the locking device, specifically the control device, every second, whereas the locking device initiates a data transmission to the server less frequently, for example only every 30 seconds.

In a particularly advantageous design of the present invention, the control device can be designed to transfer result data to the server only if at least one evaluation criterion is met. This means that a design is conceivable in which not all result data (and, where appropriate, sensor data) need to be forwarded in every case to the server, but only if they reveal characteristics which are relevant to the server or require a further evaluation and/or further measures there. This results in a further reduction in the data traffic via the network. In this case, the control device of the locking device thus decides independently whether the data originating from the sensor device and already at least partially evaluated have sufficient relevance to be forwarded to the server.

It is furthermore preferable if the control device is designed to reparameterize the sensor device and/or the locking device depending on the evaluation result. If the control device of the locking device therefore establishes a specific condition which requires a modified behavior on the part of the locking device and/or the sensor device, the control device, with no need for the server and therefore a data exchange via the network, can in certain cases make decisions for the further operation of the locking device and/or the sensor device and can adjust operating parameters of the locking device and/or the sensor device accordingly. If, for example, due to a risk to a person, which can be established from the sensor data, an opening of the lock of the locking device is not to be recommended, the locking device can be reparameterized accordingly for the duration of the occurrence of this condition, wherein in such a case a transfer of corresponding result data to the server can nevertheless appropriately take place. If it is established on the basis of the evaluation of the sensor data that a sensor data recording is required which is more frequent or is located in a different area, a reparameterization of the sensor device and therefore the sensor which it comprises is also conceivable. This means that, as operating parameters of the sensor device, operating parameters relating, for example, to the latter's data recording rate, its sensitivity and the like can be adjusted.

Operating parameters for the sensor device and/or the locking device can obviously also relate to the evaluation of the sensor data themselves, so that, for example, new threshold values and/or totally new algorithms for evaluating the sensor data can be transmitted. In addition, as already mentioned, status changes for the sensor device are included, in order, for example, to back up data, switch off equipment and the like.

A decision competence of the control device of the locking device itself is particularly appropriate if the locking system furthermore comprises at least one actuator allocated to the object and/or room, wherein the actuator is connected via a communication link to the locking device, and the control device is designed to control the actuator depending on the evaluation result and/or actuator information received from the server. This therefore means in particular that the control device can control actuators external to the locking device on the basis of the evaluation of the sensor data themselves, for example when the sensor data indicate a fire within the room, it can activate a sprinkler or other extinguishing device, if an intrusion into the room is established, it can trigger an alarm and the like. It has been recognized that, in the case of such decisions, ultimately based on simple interrelations, the intelligence that can be integrated into the locking device is already sufficient to perform corresponding functions in situ and therefore significantly faster and at the same time free the network from superfluous data that are still to be evaluated in the server. The actuator can also be connected via a bus system, in particular the same bus system as the sensor device, to the locking device and in its function, as in particular on the sensor device, not in relation to the locking function of the locking device, which is implemented via the lock.

It should again be noted that a certain intelligence in the sensor device is also extremely appropriate and preferable according to the invention, in particular the sensor device itself can be designed to be so intelligent that the evaluation device there can independently carry out the basic sensor data evaluation. It can be provided that programmed threshold values or behavioral rules can be evaluated in the sensor device on the basis of the current sensor data. If, in one example embodiment, a programmed threshold value is exceeded or understepped, the sensor device signals this to the locking device, which recognizes and interprets the deviation from the normal value in the control device and can instigate suitable measures, whether it be the control of actuators, the reparameterization of the locking device and/or the sensor device and/or the immediate communication to the server of the event that has occurred.

Sensor devices can thus carry out complex evaluations in real time, for example analyzing oscillations (vibrations of hard disks, earthquake damage, intrusion attempts and the like) or perform an image processing. The complex sensor data can thus be reduced to a less complex statement, for example measurement values can therefore be output on a significantly reduced scale, for example 256 levels only. Threshold value considerations can be reduced to a yes-no statement and the like. In this way, events are recordable in the millisecond range without burdening the network. A data reduction of this type is appropriate whenever only rough values and limit values are decisive for monitoring.

The aforementioned actuators can also have a certain intelligence, so that, for example, it can be provided that the actuator is designed as a computing device, for example a microprocessor, for converting control information received from the locking device into specific actuator measures. Due to the dedicated intelligence of the actuator which is implemented, for example, by a control unit, said actuator can independently perform complex tasks. Control information, for example status data, is transmitted to the actuator, which responds to this control information and triggers actions, for example a shutdown of an electric power supply, a starting of a cooling process, a triggering of an alarm and the like. An activation of actuators is possible from the locking device, in particular in combination with the evaluation of the sensor data. Thus, for example, as already described, a fire in the room to be locked can immediately activate the sprinkler system in the room and/or open and/or close the door and/or windows.

As already explained, a control of the actuators can obviously also take place from the server if the locking device receives corresponding actuator information resulting in a reparameterization or activation of the actuator. Actuator information of this type can result from a further evaluation of the sensor data or result data by the server, or also through a direct input, for example by operating personnel, on the server.

In a preferred design, the locking device is designed to receive operating power required for its operation from the network. Concepts of this type, in which components connected to a network similarly obtain their operating power via the network, are already known in the prior art. Locking devices which receive the required operating power via the Ethernet-based network, known by the name of “Power over Ethernet” (PoE), can be quoted here as an example. In this way, only one connection per locking device is required for the operating power and the data to be exchanged via the network.

A particularly preferred design of the invention provides that the control device is designed for the cyclical transmission of status information to the server. In this way, the status of the locking device (and preferably also the sensor device and, where appropriate, the actuator) can be cyclically checked. This is essential for determining an overall status of the system and furthermore offers the facility to “order” the data traffic in the locking system after each locking device in normal operation finally exchanges data with the server at this time only. Particularly in a locking system with many locking devices, the required activity and the required distribution of data traffic in the network can be achieved in this way, in particular through selection of the corresponding cycle times which, for example, may be five to five hundred seconds. The status information can contain the result data and/or at least one status parameter describing the operating status of the locking device and/or the sensor device (and, where appropriate, the actuator). Consequently, the locking devices signal to the server in a user-defined or automatically defined time frequency in order to minimize the traffic in the network.

It should again be noted at this point that it is possible due to the temporal free design of the cycle time for various locking devices to define locking devices with high signaling priority, for example those relating to particularly important objects and/or rooms.

A further development of the invention provides that the server is designed to transmit response information on receipt of status information of the locking device to the locking device. Whenever the server receives the status information of a locking device, it thus transmits, if necessary after processing this status information, response information to precisely the locking device whose status information it has received. In this way, the cyclical communication is completed in that, on the one hand, the server receives the status information of the locking device and consequently all components connected to it at defined times and uses the same time to supply the locking device with a corresponding response, which particularly preferably comprises the current operating parameters. It is particularly appropriate here if the response information comprises at least one operating parameter for the locking device and/or the sensor device and/or the actuator, wherein the control device is designed to set the locking device and/or control the sensor device and/or the actuator according to the at least one operating parameter. Specifically, the operating parameter or one operating parameter may be a cycle time for transmitting the status information. A multiplicity of different operating parameters and other information are of course also conceivable, which may be contained in the response information, for example also actuator information to control actuators.

It can therefore be specifically stated that, with the periodic signaling, the locking device transmits its status information to the server and receives back response information with a set of operating parameters. This set of operating parameters may, for example, contain the cycle time (signaling period) and possible further statistical parameters which are immediately stored and applied in the locking device and, where appropriate, in the sensor device and the actuator. However, it should be mentioned at this point that a particularly advantageous design of the invention provides that required information for opening the locking device, for example a code or the like, is ideally never present in the locking device itself, as will be explained in detail below. This ultimately increases security enormously, since no intrusion through unauthorized opening of the lock is possible only when a locking device is present, since ideally the required information cannot be removed from the locking device itself.

A particularly advantageous embodiment of the invention in this context provides that the control device is designed to transmit event information to the server immediately on the occurrence of an event described by an event criterion. This therefore means that, along with the periodic transfer of status information typical in normal operation, it is also quite possible for certain events to trigger an immediate transmission of event information to the server, wherein these events are described accordingly by event criteria internally in the control device.

An event criterion of this type may be an event criterion relating to the event data. This means that, if a status change which requires a notification of the server is established through the evaluation of the sensor data, this status change is forwarded to the server immediately and outside the normal cycle. This can also take place in addition to a performance or instigation of measures in the locking device itself, as already described in detail. If the control device of the locking device recognizes, for example, a deviation from a normal value exceeding a threshold value in the sensor data or intermediate results derived therefrom, this can be signaled to the server, which, in this case also, can transmit response information accordingly, which means that the server can be designed to transmit response information to the locking device on receipt of event information. Depending on evaluation by the server of the event information, for example event data, response information of this type may be a reparameterization, actuator information and the like. It should be noted here that the response information may also be coded similarly to the response information in the transmission of the status information, preferably even totally identically, and may therefore also contain a set of parameters and, where appropriate, further data, i.e., for example, actuator information.

The event criterion may additionally or alternatively also be an event criterion relevant to an opening operation action for the lock. This therefore means that the operation of the locking device, in particular for the purpose of opening, can also be regarded as an event, which justifies an immediate signaling to the server. This is essential, particularly if the access information for the locking device, for example a required code or the like, is not stored in the locking device, but, which is preferable, is checked in connection with in particular an encrypted communication between the locking device and the server, which will be discussed in detail below.

On the whole, the design described above ideally provides that a normal operation exists in which status information is cyclically transferred to the server and is processed there, whereupon response information is returned, in each case containing the current set of parameters for the operation of the locking device and ideally the at least one sensor device, and, where appropriate, the at least one actuator. In clearly defined special cases, i.e. on the occurrence of an event criterion, which occurs significantly less frequently, a transfer of event information to the server also takes place outside the cycle, said information similarly being evaluated and considered with corresponding response information. It should be noted here that the return transfer of response information by the server in the case of event information may also be optional, which means that, if the server establishes that the message of the locking device is received outside the cycle and no measure whatsoever is needed, no response to this is required either. Given that a transmission on the occurrence of an event criterion takes place rather infrequently, a design of this type on the whole admittedly always offers a fast contactability of the server, but on the whole allows the data traffic in the network to be regulated through corresponding settings of cycle times and to be reduced to the required level.

The locking device preferably has an operating device and/or a read-out device reading out an identification medium and/or the or a sensor device having an in particular biometric sensor to determine code information for opening the lock. Various options therefore exist for determining code information which is intended to result in the opening of the lock of the locking device. Operating devices with at least one operating element, for example a keypad, a combination lock and the like are therefore essentially conceivable, but also the use of biometric sensors, for example a camera in general, a sensor scanning the eye (iris scanner), a fingerprint-measuring device and the like, which sensors can otherwise belong to the sensor devices which are connected to the locking device, so that the sensor devices and/or the locking device then in turn accordingly carry out a preliminary evaluation in order to determine the code information. It should be noted here that a combination of opening operations is also quite possible, for example first of all the identification of a user via biometric sensors after which an opening code can be entered via an operating device.

It is particularly appropriate for this purpose if access information with which the code information is compared is not stored directly on the locking device itself, wherein, in particular, as described above, if an event criterion is satisfied, a communication can take place with the server. Thus, it can be specifically provided that the control device is designed to transmit the code information immediately after its determination, particularly in encrypted form, to the server, wherein the server is designed to compare the code information with access information stored on the server for the locking device on receipt of the code information and to transfer, particularly in encrypted form, opening information dependent on the comparison result to the locking device. Thus, if code information is entered on the locking device, for which purpose a magnetic card reading device and the like can furthermore be used as a read-out device, the control device, after it has been connected via the network to the server, sends the code information, preferably in encrypted form, to the server. There, the data are decrypted and compared with access information for the locking device stored in the database of the server. If a match occurs, the code is consequently correct, and the server generates opening information (release code), preferably in encrypted form, which is transferred back to the locking device. The opening of the lock then takes place there. If the code information does not match the access information, no opening information is accordingly generated and at least one operating parameter of the access refusal which may, for example, trigger a corresponding output, e.g. the flashing of a red LED, is sent with the response information to the locking device.

It should be noted here that the described preferred encryption can be used in two ways, preferably cumulatively, i.e., on the one hand, through encryption of the data link via the network itself and, on the other hand, through the encryption of the data, specifically the response information. This will be explained in detail below.

In each case, this design ensures that the access information is not required at any time on the locking device, and consequently cannot be read out from the latter without authorization.

In a particularly preferred further development of the locking system according to the invention, it is provided that the server and/or the control device is designed to generate new, in particular locking-device-specific, encryption information for the communication with the locking device or the server for each communication with the locking device or the server, and the locking device and the server are designed to encrypt and decrypt every communication with the server or the locking device according to the current encryption information. The communication of the locking devices with the server consequently takes place in encrypted form, wherein the key for the data encryption is automatically changed with each communication with the server. In one example embodiment, it is, for example, conceivable to generate encryption information or the associated keys on the basis of the MAC address of the locking device and the current time using a random number generator. The great advantage of this design is that the opening information (release code) already described, which causes the lock to open, is never identical and cannot therefore also be determined through interception of communications via the network. Together with a design in which the locking device itself thus contains no access information whatsoever, an extremely high security level is consequently achieved in addition to the already mentioned reduction in the data traffic in the network. Furthermore, in order to make the encryption information at least accessible to the communication partner, a part of the encryption information enabling the encryption, for example a public key, preferably itself encrypted with the still currently used, previous encryption information can be transferred with the already repeatedly discussed response information in a communication to the locking device, specifically the control device, or with status information or event information to the server. Designs are also entirely conceivable in which only the server generates the current encryption information.

A further advantage of the design in which the locking devices do not know their own access information is moreover that the locking device can simply be separated from the network (and therefore simultaneously or additionally from the power supply). As soon as electric power is again available to the locking device, specifically the control device, it can again register in the network and therefore with the server.

The possibility furthermore arises from this that a locking device can be configured at a specific location, and can then be removed from the network in order to be reconnected at a different location to a different network which, however, has the same configuration. There, it can then be opened if identification information of the locking device, for example the MAC address, and, if the constantly changing encryption takes place, the last encryption information are known.

Finally, it should also be noted at this point that the release for a locking device can also be issued via the Internet. If, for example, a container at a location, for example in Hamburg, is locked, it can, with use of the Internet as a network, be released for opening at a different location, for example in Singapore, by the owner at the first location.

Furthermore, the locking system can preferably have at least one portable ancillary device connectable via an allocated connection, in particular different from the connection for the network, to the locking device for the configuration of and/or emergency access to the locking device. This means that an ancillary device/handset can be used for the configuration and/or for emergency access which can be connected to the locking device via a connection, ideally separated from the network connection, so that a communication link is set up. Here, the resulting, for example serial, communication link is preferably encrypted and/or data stored on the ancillary device are decryptable by the control device. The ancillary device can appropriately have a power supply for the locking device, particularly if the locking device is normally supplied with power from the network.

On the one hand, an ancillary device of this type can be used to configure a locking device to be newly incorporated into a locking system by transferring suitable configuration data by means of the communication link to the ancillary device and by using said data so that a communication is enabled in the network, wherein, however, a specific network address is preferably never known on the ancillary device for security reasons, which will be examined in further detail in relation to the method to be subsequently described for the configuration of a locking device in the locking system communicating with the server via the network.

On the other hand, the ancillary device can, however, also be used for emergency access, wherein it is appropriate if a master code for opening the lock of the locking device is provided or is storable on the ancillary device, particularly in encrypted form. This master code can be compared with a master code in the locking device or a master code entered on the locking device, wherein the first case is preferred in that the master code is thus never completely known. The master code can appropriately be changed on a regular basis, for example by the server with each communication with the locking device in connection with the transmission of response information and/or with each successful opening of the lock. Current information on the master code must then also be supplied to the ancillary device, in particular through connection to the server, if emergency access is to take place on a specific locking device.

It should be noted here that the use of a master code is of course also essentially conceivable without the use of an ancillary device. Although the described variant using the ancillary device, in the event of a power failure or the like, already enables high security and nevertheless a facility for opening, such a situation is nevertheless also possible if the server is designed to transmit a master code as part of response information. This master code appropriately changes automatically, for example after each successful opening operation of the lock, and permits an opening even without a connection to the server, wherein the operating power in this case can originate from a battery or the ancillary device which is nevertheless used. Accordingly, it is generally preferred if a master code of the ancillary device and a master code of the locking device are compared without said codes actually being known.

A further appropriate design provides that more than one sensor device is allocated to the locking device, wherein the control device is designed for the combined evaluation of sensor data of a plurality of sensors to produce result data. The locking device can consequently be constructed to be so intelligent that a higher-order evaluation can take place for a multiplicity of sensor data of different connected sensor devices. Thus, for example, in the case of an assembly rack of a data center, a temperature increase on one temperature sensor above 60° C. can still be regarded as plausible, wherein, however, for example, five or more temperature increases of this type can indicate the outbreak of a fire. In a different example embodiment, a vibration in the lower frequency range in combination with a glass break can indicate an intrusion attempt. Consequently, in the case of a plurality of provided sensor devices, links of the sensor data to produce further result data along the lines of a collective evaluation are also possible, which may have the calculating consequences, for example the fulfillment of an event criterion and thus the notification of the server, the control of an actuator, and the reparameterization of the locking device and/or the sensor device. The server in turn is again able to make higher-order inferences not only from result data/sensor data relating to individual sensor devices, but also from the collective evaluations of the locking devices.

As already mentioned, more than one locking device can be provided in the locking system according to the invention for the full use of the advantages of the present invention, wherein large numbers of locking devices can also be easily operated via a network on the basis of the data reduction taking place. Thus, for example, it is conceivable that the locking system can have 1,000-5,000 locking devices, for example 4,000 locking devices. Furthermore, if, as preferred example embodiments of the invention provide, access information is not present on the locking devices themselves and changing encryptions are preferably used, extremely high security is furthermore achieved despite the low data traffic.

As already explained, the present invention can be applied particularly advantageously to a data center in which the different assembly racks, in which in each case at least one computer unit can be assembled, are in each case equipped with a correspondingly designed locking device and sensor devices monitoring the assembly rack which are connected to the locking device. In this context, the locking devices can be addressed and operated via the same network via which the computer units also communicate with one another. Sensor devices for assembly racks of this type may comprise temperature sensors, vibration sensors and the like; actuators for assembly racks of this type may comprise cooling devices, emergency switching devices to disconnect the power supply and the like. A data center with a plurality of assembly racks and a locking system according to the invention is also generally conceivable, wherein at least one locking device is allocated to each assembly rack.

Along with the locking system, the present invention also relates to a method for operating a locking system according to the invention, wherein the sensor data received from the sensor of the sensor device are at least partially evaluated by the control device and/or the evaluation device and at least a part of the result data obtained in the evaluation is transmitted to the server. All statements relating to the locking system according to the invention can be transferred analogously to the method according to the invention, with which the aforementioned advantages can consequently also be gained.

In the context of the present invention, but also independently from an at least partial evaluation of the sensor data in the locking device and/or the sensor device, an appropriate configuration method is conceivable for locking devices which communicate via a network with a server. A method for the configuration of a locking device in a locking system communicating with a server via a network has proven to be specifically advantageous, wherein the locking device is addressed via a network address, said method having the following steps:
selection of configuration data comprising a temporary network address and of a permissible address range for the network address of the locking device by the server,
transmission of the configuration data to an ancillary device,
connection of the locking device to the network and of the ancillary device to the locking device,
configuration of the locking device using the configuration data with the temporary network address, transmission of a readiness signal from the locking device to the server,
selection of an available network address from the permissible address range by the server, and allocation and transmission of the available network address to the locking device,
configuration of the locking device with the selected, available network address and deletion of the temporary network address in the network.

So that the locking devices, which comprise a lock for a room and/or an object, can be addressed in the network, a specific network address must be allocated to them, it is extremely beneficial to security if, on the one hand, this network address is not publicly known but, on the other hand, a single ancillary device can be used for the configuration of all locking devices without containing previously stored network addresses for all these locking devices. In the method described here, it is thus provided that initially only the normal configuration data, for example, for a TCP/IP network, the server, the subnet mask, where appropriate a standard gateway and the like, and in addition to these configuration data, a single temporary network address, in particular an IP address, and a permissible range of network addresses available for the locking devices to be configured must be indicated on the server, for example using suitable software, as necessary parameters of the network connection for all locking devices to be configured. If the configuration data and the permissible address range are already known, it is merely necessary to transmit the configuration data onto the ancillary device, which can then be connected to a locking device to be configured, in particular via a connection provided in addition to the network connection. The configuration or commissioning can be initiated by an operating action by the locking device or the ancillary device. The control device of the locking device then receives the configuration data from the ancillary device and can register with the network by means of these configuration data and the temporary network address.

The locking device then contacts the server, which then allocates to it a new network address from the permissible address range. In order to be able to identify the locking device subsequently also, it is extremely appropriate in this connection if the readiness signal comprises at least one identification datum of the locking device, and the server, following the selection of the available network address, creates and stores a dataset containing the identification datum and the selected available network address allocated to the latter. This therefore means that the server creates a dataset with the data of the newly registered locking device.

The temporary network address can then be deleted once more from the network, and the locking device is registered and ready for operation. This can be accomplished in an extremely short time. Immediately thereafter, the ancillary device can be plugged into the next locking device to be configured and the process begins anew, with the same temporary network address. The locking device then receives a different free network address from the permissible address range.

Consequently, this configuration method offers a very great advantage, particularly in respect of the configuration of a large quantity of locking devices, for example when a new locking system is commissioned, since the ancillary device needs to be configured only once and then needs to be connected successively for only a short period to all locking devices to be configured, while the avocation of the actual final network addresses can be performed fully automatically by the server using the predefined permissible address range. A simple and effective way of setting up a locking system with a large number of locking devices is thus provided.

Further advantages, features and individual characteristics of the present invention are described in the following presented example embodiments and with reference to the drawings, in which:

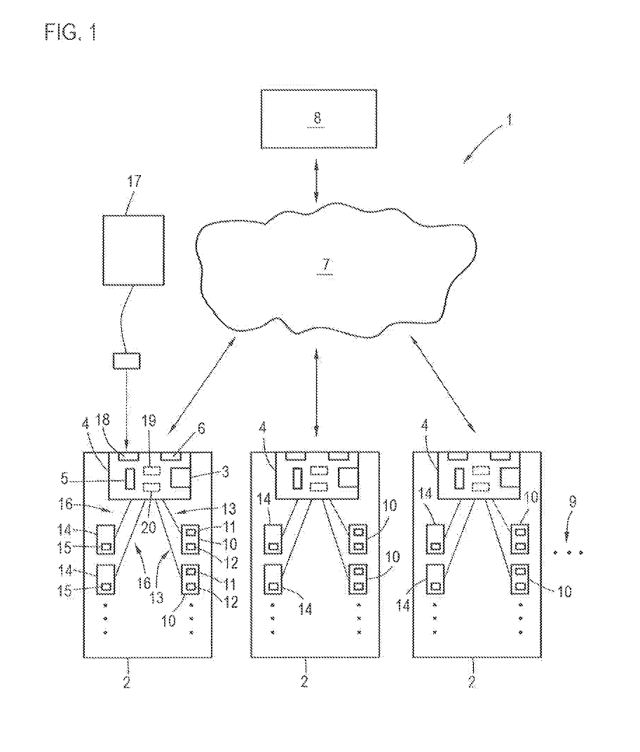

FIG. 1 shows a schematic drawing of a locking system according to the invention,

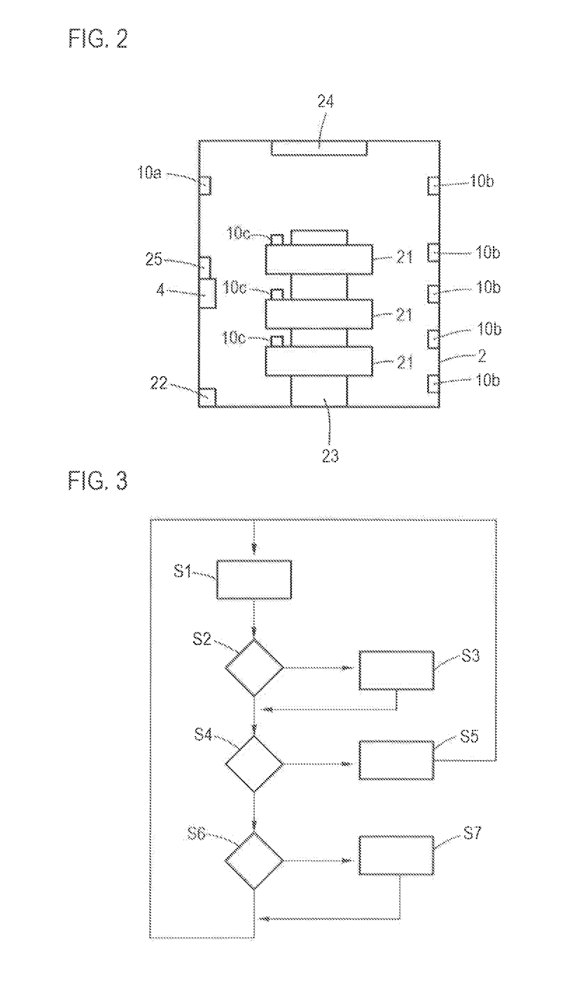

FIG. 2 shows a schematic diagram of an assembly rack,

FIG. 3 shows a flowchart for the sensor data monitoring,

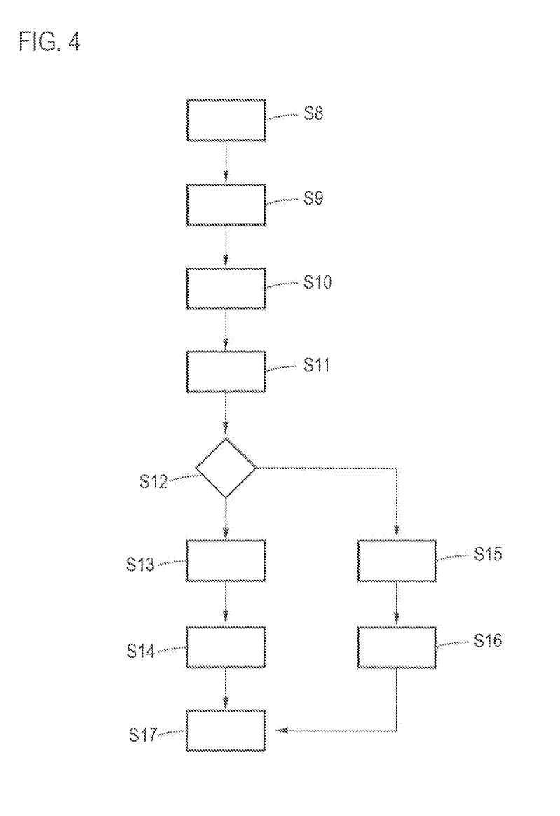

FIG. 4 shows a flowchart for the opening of the lock of a locking device, and

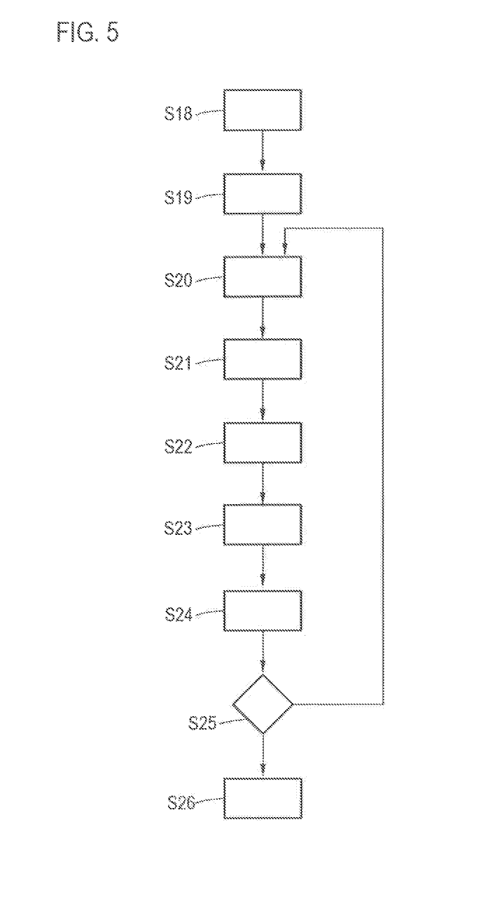

FIG. 5 shows a method for configuring locking devices in a locking system.

FIG. 1 shows a schematic drawing of an example embodiment of a locking system 1 according to the invention. Here, the latter has a multiplicity of objects/rooms to be locked, which, in the present example embodiment, are formed in a data center by means of assembly racks 2. However, other objects and/or rooms are obviously conceivable.

In order to be able to lock the assembly racks 2 and therefore protect them against unauthorized access, each of the assembly racks 2 can be locked by means of a lock 3 of a locking device 4 allocated to the assembly rack. The locking device 4 in each case has its own intelligence in the form of a control device 5, of which the precise modes of operation will be explained in detail below.

The locking devices 4 can be connected via a network connection 6 to a network 7, here an Ethernet, so that they can communicate via a specific protocol, here TCP/IP4 or TCP/IP6, with a server 8, i.e. a central computing device. As indicated by the continuation symbols 9, a multiplicity of assembly racks with a multiplicity of locking devices, and obviously also not assembly racks 2, but locking devices 4 allocated to other devices, can be connected in the network 7 to the server 8, for example 4,000 locking devices 4.

To monitor the assembly racks 2, sensor devices 10 are furthermore built into the latter which, along with the sensor 11, for example, a temperature sensor, a vibration sensor or an integrity sensor, in each case also have an evaluation device 12, via which a fundamental evaluation of the sensor data recorded with the sensors 11 can already be carried out.

The sensor devices 10 are not connected directly to the network 7, but via a respective communication link 13, which is preferably implemented via a bus system, to the locking device 4 of the respective assembly rack 2.

Furthermore, actuators 14, which in each case have a computing device 15, for example a microprocessor as a control unit, for converting control information into corresponding actuator measures, are also allocated to each assembly rack. The actuators 14 are also connected via communication links 16 to the locking device 4, preferably using the aforementioned bus system. The communication links 13, 16 can be implemented via an internal bus system of the assembly rack 2.

The locking system 1 furthermore also has at least one portable ancillary device 17 (handset), which can be connected via a special, for example serial, connection 18, which does not correspond to the network connection 6, to the locking device 4. As will be explained in further detail, the ancillary device 17 serves to configure locking devices 4 newly added to the locking system 1 and, in an emergency, in particular therefore in the event of a network failure and/or power failure, to be able to effect an opening of the locking device 4. For this purpose, it is furthermore provided that a new master code is generated with each successful opening of the lock 3 of the locking device 4 by the server 8 and is stored in the locking device 4, wherein, for the opening, the master code known on the server 8 can be transferred onto the handset 17, obviously in encrypted form, where, on connection, it can then be compared with the master code stored in encrypted form in the locking device 4, specifically the control device 5. An alternative example embodiment provides that the master code is not known in the locking device 4, but is merely transported via the ancillary device 17 to the locking device 4 and can be entered there via corresponding operating devices, here shown optionally at 19, in order to be compared by means of encrypted communication with the master code stored in the ancillary device 17.

In order to be able to carry out opening actions to open the lock 3, various possibilities are conceivable, one of which is the provision of an operating device 19 with at least one operating element; for example, this may involve a keypad, a numeric keypad and the like. Additionally or alternatively, the locking device 4 can have a read-out device 20 for an identification medium, for example a magnetic card. In a third, additionally or alternatively provided design, one of the sensor devices 10 may comprise a biometric sensor as a sensor 11, which records biometric features of an operating person as code information to open the lock 3. One example embodiment provides that an identification of a user first of all takes place via a sensor device 10, whereupon a code/PIN is also to be entered via an operating device 19.

The locking devices 4 receive the operating power necessary for their operation from the network 7 according to the so-called “Power over Ethernet” principle (PoE).

The evaluation of the sensor data recorded by the sensors 11 already takes place in a distributed manner in the various devices of the assembly rack 2. As already mentioned, a first preliminary evaluation, for example a comparison with threshold values and/or a reduction in the gradation, in which sensor data may be present, is already carried out in the evaluation device 12 of the sensor device 10. The sensor data preliminarily evaluated in this way are transferred via the communication link 13 to the control device 5 of the locking device 4, where they are subjected to a further evaluation in order ultimately to obtain result data which are significantly reduced compared with the sensor data (but may still contain however sensor data themselves) and can be transferred at least partially via the network 7 to the server 8. Furthermore, however, the control device 5 is itself also designed to instigate measures already on the basis of the evaluation result, for example a reparameterization of the locking device 4 of at least one sensor device 10 and/or at least one actuator 14. Actuator measures can also be immediately instigated.

A transfer of result data to the server 8 is effected in normal operation within the cyclical transmission of status information from the control device 5 to the server 8. This status information contains, on the one hand, at least one status parameter describing the operating status of the locking device 4 and/or the sensor devices 10 and/or the actuators 14, which is ultimately used by the server to check the operational readiness of the corresponding devices and to detect non-time-critical events. However, the status Information also contains result data and, where appropriate, sensor data also, wherein, for example if sensor data are received from the sensors 11 in the normal case more frequently than the status information is transferred to the server 8, an averaging, for example, can take place over this period in respect of the result data, but other statistical evaluations of the progression of the result data can also be transferred to the server 8.

A cascaded intelligence with successive data reduction is thus implemented in each assembly rack 2. If, for example the sensor 11 supplies new sensor data with a timing in the millisecond range, said data can be preliminarily evaluated by the evaluation device 12 and can be transmitted, for example at one-second intervals, to the control device 5 of the locking device 4. The latter can in turn forward result data to the server 8 in a cycle time of, for example, 30 seconds, said data being significantly reduced in their data volume so that the data traffic in the network 7 is significantly reduced. The actual selection of the cycle time depends ultimately on how much bandwidth the network 7 has available for the data exchange with the locking devices 4, and how many locking devices 4 are present. Longer cycle times, for example in the 400-second range, are also quite conceivable. A prioritization of specific locking devices 4, to which a cycle time is then allocated as an operating parameter which is higher than that allocated to other locking devices 4, is furthermore possible.

Whenever the server 8 receives status information from a locking device 4, response information is also transmitted with a parameter set of the current operating parameters for the locking device 4, the sensor devices 10 and the actuators 14. The response information may also contain actuator information to control the actuators 14.

This entire data exchange via the network 7 takes place in encrypted form, not only by means of an encrypted connection between the control device 5 and the server 8 per se, but additionally by means of an encryption of the transmitted data, which preferably changes with each communication. New encryption information, for example depending on the MAC address of the locking device 4 and the current timestamp, is then generated by the server 8 with a random number generator and is transmitted in the response information at least partially to the control device 5 so that the current key is known there also. In this way, specific transmissions, in particular opening information resulting in the opening of the lock 3, cannot be meaningfully intercepted. Methods in which the locking device 4 and the server 8 in each case partially generate the encryption information are also conceivable.

Along with this cyclical transfer of status information, which can also be referred to as “heartbeat”, the control device 5 can also instigate a transmission out of order on the occurrence of specific event criteria, for example an opening attempt or specific result data, which will be in discussed in detail below.

FIG. 2 shows more precisely a schematic diagram of an assembly rack 2 in an example embodiment. A plurality of computer units 21 can be seen to be assembled in the assembly rack 2. The locking device 4 is disposed in the vicinity of a door not shown in detail. As this is made of glass, the sensor device 10a has a glass break sensor. Sensor devices 10b having temperature sensors are disposed in a distributed manner in the assembly rack 2. A sensor device 10c comprising a vibration sensor is furthermore assigned to each computer unit 21.

Here, the assembly rack 2 has an emergency OFF switch 22, a cooling device 23 and a sprinkler system 24 as actuators 14.

As the control device 5 of the locking device 4 is designed for the joint evaluation of the sensor data/result data of a plurality of sensor devices 10, 10a, 10b, 10c, higher-order inferences can already be made in the locking device 4. Thus, for example, it may not yet result in an action if only one of the temperature sensors of the sensor devices 10b indicates a temperature above 60°, but if this occurs for a plurality of temperature sensors, for example three or more temperature sensors, a fire can be inferred and the sprinkler system 24 can be activated, while the emergency OFF switch 22 disconnects the power supply to the computer units 21 and, where appropriate, the actuators 14. Corresponding event information is transferred to the server 8. If vibrations in the low frequency range are detected by means of the sensor devices 10c and if the sensor device 10a simultaneously recognizes a glass break, an intrusion can be assumed and an output means 25 for an alarm can be controlled, while corresponding event information is obviously also transmitted to the server 8.

FIG. 3 now shows a flowchart for the monitoring of sensor data. As already described, in a step S1, the evaluation of sensor data to produce result data takes place in the evaluation device 12 and the control device 5. In a step S2, it is checked whether the evaluation result has specific measures which are to be carried out by the control device 5 itself as a consequence. A reparameterization of the locking device 4, at least one sensor device 10 and/or at least one actuator 14 comes into consideration if an uncritical event occurs which, however, for example warrants a more precise measurement or makes a stronger cooling by a cooling device 23 seem appropriate. However, measures such as the triggering of the sprinkler system 24, i.e. the specific control of actuators 14 in a critical case, are also conceivable. Changes may also occur on the locking device 4 or on the lock 3, for example in some cases an opening or permanent closing of the lock 3. The control device 5 is itself consequently designed, at least to a limited extent, to undertake measures in the case of specific occurring result data, which takes place in summary form in a step 33. Circumstances resulting in such measures can be described specifically by measure criteria which are evaluated in step 32.

In a step 34, it is then checked whether an event criterion is met on the basis of the result data which would result in an immediate notification, i.e. lying outside the cyclical transmission, of the server 8. If so, event information describing the event is created and transferred to the server 8, step 35, which server, on receipt of the event information, evaluates the latter, subjects in particular the result data to a further, higher-order evaluation and decides whether further measures are required. If so, response information is transferred back to the control device 4, which then converts said information into corresponding measures, for example sets the similarly transmitted operating parameters and/or controls the actuators 14 in accordance with transmitted actuator information.

In a step S4, it is checked whether the signaling interval has elapsed, i.e. whether a cyclical transmission of status information is to therefore take place. If so, the latter is compiled and transferred in a step 37 to the server 8, which transmits the corresponding response information.

It should again be noted that the encryption changes for each communication with the server 8.

It is also noted at this point that the response information from the server 8, obviously in the form of operating parameters for the locking device 4, can also influence the communication behavior itself, for example through transmission of a new cycle time, new criteria, in particular event criteria, to be applied, and the like.

Event criteria do not necessarily have to be satisfiable by result data only, but also relate in particular to an opening operation for the lock 3 of the locking device 4, in particular corresponding operating actions. Such a situation is explained in detail by the flowchart in FIG. 4. There, it is initially established in a step S8 that an opening operation occurs, for example therefore an identification process has been initiated via a biometric sensor, an operating action has occurred on the operating device 19 or an identification medium has been transported to or by the read-out device 20. Code information making it possible to establish whether the correct opening actions, which are consequently to be compared with access information, have been carried out for this lock, is collected and compiled within the control device 4 in a step 9 by means of the correspondingly carried out opening actions. However, this access information is not stored in the locking device 4 so that, once an event criterion is met due to the occurrence of the opening actions, the code information is transmitted in a step S10 as event information to the server 8 according to the current encryption.

If it is received there, a comparison takes place in step S11 with access information stored on the server, which can furthermore also be definable by the server. If the comparison produces the result, step S12, that the code information matches the access information, opening information (release code) is generated in a step S13, encrypted according to the current encryption and sent back to the control device 4 of the same locking device where, in a step S14, it is received, decrypted and results in an opening of the lock 3. It should be noted here that, due to the constantly changing encryption, the data packet dispatched via the network 7 cannot be recognized from outside as opening information.

if the code information and access information do not match, blocking information is generated in a step S15 and similarly transferred back to the control device 5 of the corresponding locking device 4 as response information. In a step 316, corresponding measures are initiated to transfer this to the operator, for example the activation/flashing of red LEDs on the output means 25, which may furthermore also be integrated into the locking device 4.

In a step 317, the opening procedure ends accordingly.

It should also be noted that, following recognition of code information matching the access information in step 313, an updating of the master code can also take place, as already explained.

FIG. 5 finally shows the flowchart of a method for configuring a multiplicity of locking devices 4 in a locking system 1. This method begins in a step S18 with the input and compilation of various data on the server 8, which can be entered partially by an operating person. Specifically, a set of configuration data is compiled which in the present case contains the IP address of the server 8, the subnet mask and a standard gateway, but may obviously also contain further parameters for setting up a connection in the network 7, as are essentially known. In particular, however, the configuration data also contain a temporary network address, i.e. a temporary IP address. Furthermore, in step S18, a permissible address range of network addresses is also defined for the locking devices 4 to be newly registered and is stored on the server.

The configuration data without the permissible address range are transmitted in a step S19 to the ancillary device 17 and are stored there.

A person with the ancillary device 17 then proceeds to a locking device 4 to be configured and connects the ancillary device there in a step S20. If it has not yet happened, the locking device 4 is to be connected simultaneously to the network 7. A configuration operation is then started by the ancillary device 17 or the locking device 4 by accessing the configuration data in the ancillary device 17 so that the locking device 4 is configured for the network 7 and initially receives the temporary network address allocated as an IP address, step S21. The locking device 4, specifically therefore the control device 5, then transmits a readiness signal in a step S22 to the server 8, which receives this in a step S23 and selects an available network address which has not yet been allocated from the permissible address range. As the readiness signal also contained an identification datum of the locking device 4, for example the latter's MAC address, the server 8 then also creates a data set in step S23 for the locking device 4 in order to be able to identify the latter in the ensuing process and in which further operating data for the locking device 4 can also be stored. In each case, the data set contains the selected available network address and the identification datum. A corresponding database can be created on the server 8 for this purpose.

In a step S24, the locking device 4, specifically the control device 5, receives the selected available network address and sets this as its now permanent IP address, whereupon the temporary network address is once more deleted.

In a step S25, it is then checked whether all locking devices have been configured. If not, step S20 is started for the next locking device to be configured. Otherwise, the method ends in step S26. In this way, a configuration of even a large number of locking devices 4 can be carried out simply and quickly.

1. Locking system, comprising:
at least one locking device having a control device designed for communication with at least one central server via a network, with a lock for locking a room and/or an object and a sensor device allocated to the room and/or object, wherein the sensor device is connected via a communication link to the locking device, wherein the control device and/or an evaluation device of the sensor device is designed to evaluate the sensor data received from a sensor of the sensor device, and the control device is designed to transfer at least a part of the result data obtained in the evaluation to the server.

2. Locking system according to claim 1, wherein the control device is designed to transfer result data to the server only if at least one evaluation criterion is met and/or to reparameterize the sensor device and/or the locking device depending on the evaluation result.

3. Locking system according to claim 1, further comprises at least one actuator allocated to the room and/or object, wherein the actuator is connected via a communication link to the locking device, and the control device is designed to control the actuator depending on the evaluation result and/or actuator information received from the server.

4. Locking system according to claim 3, wherein the actuator is designed as a computing device for converting control information received from the locking device into specific actuator measures.

5. Locking system according to claim 1, wherein the control device is designed for the cyclical transmission of status information to the server.

6. Locking system according to claim 5, wherein the server is designed to transmit response information on receipt of status information of the locking device to the locking device.

7. Locking system according to claim 6, wherein the response information comprises at least one operating parameter for the locking device and/or the sensor device and/or the actuator, wherein the control device is designed to set the locking device and/or control the sensor device and/or the actuator according to the at least one operating parameter.

8. Locking system according to claim 5, wherein the control device is designed to transmit event information to the server immediately on the occurrence of an event described by an event criterion.

9. Locking system according to claim 8, wherein at least one event criterion is an event criterion relating to the result data and/or at least one event criterion is an event criterion relevant to an opening operation action for the lock.

10. Locking system according to claim 8, wherein the server is designed to transmit response information to the locking device on receipt of event information.

11. Locking system according to claim 1, wherein the locking device has an operating device and/or the or a sensor device having an in particular biometric sensor and/or a read-out device reading out an identification medium to determine code information for opening the lock.

12. Locking system according to claim 11, wherein the control device is designed to transmit the code information immediately after its determination, particularly in encrypted form, to the server, wherein the server is designed to compare the code information with access information stored on the server for the locking device on receipt of the code information and to transfer, particularly in encrypted form, opening information dependent on the comparison result to the locking device.

13. Locking system according to claim 1, wherein the server and/or the control device is designed to generate new, in particular locking-device-specific, encryption information for the communication with the locking device or the server for each communication with the locking device or the server, and the locking device and the server are designed to encrypt and decrypt every communication with the server or the locking device according to the current encryption information.

14. Locking system according to claim 1, further comprising at least one portable ancillary device connectable via an allocated connection, in particular different from the connection for the network, to the locking device for the configuration of and/or emergency access to the locking device.

15. Locking system according to claim 14, wherein a master code for opening the lock of the locking device is provided or is storable on the ancillary device, particularly in encrypted form.

16. Locking system according to claim 1, wherein more than one sensor device is allocated to the locking device, wherein the control device is designed for the combined evaluation of sensor data of a plurality of sensors to produce result data.

17. Method for operating a locking system according to claim 1, wherein the sensor data received from the sensor of the sensor device are at least partially evaluated by the control device and/or the evaluation device, and at least a part of the result data obtained in the evaluation is transmitted to the server.
